(19) United States
(12) Patent Application Publication
(10) Pub. No.: US 2019/0141005 A1
(43) Pub. Date: May 9, 2019

(54) SYSTEM AND METHOD FOR SENDING OBITUARY NOTICES

(71) Applicant: OBIT SOLUTIONS LTD., Ramat Hasharon (IL)

(72) Inventor: Oran YARKONI, Ramat Hasharon (IL)

(73) Assignee: OBIT SOLUTIONS LTD., Ramat Hasharon (IL)

(21) Appl. No.: 15/993,941

(22) Filed: May 31, 2018

(30) Foreign Application Priority Data
Nov. 9, 2017 (IL) 255568

(51) Int. Cl. H04L 12/58

(52) U.S. Cl. CPC H04L 51/36; H04L 51/10; H04L 51/046

(57) ABSTRACT

A system and method for sending a death notice comprising: creating the notice on a mourner app running on a computing device; retrieving, by a retrieval app running on deceased contact storage device, contacts stored in the deceased contact storage and transferring retrieved contacts to the mourner app; sending by the mourner app of the notice to at least one of the retrieved contacts.

### FIELD OF THE INVENTION

The invention relates to a system and method for managing obituaries/notices and particularly for sending such notices, managing responses and guiding users to related service providers.

### BACKGROUND OF THE INVENTION

The traditional print format of obituaries is no longer relevant since print media is not read by today's online population. Additionally, mourners often need to pay to place an obituary in print media. Notice of the passing must ideally be sent very quickly to allow those wishing to pay respects to attend the funeral or reach out to the family, and online methods would appear to provide a solution. However, notifying family, friends, and colleagues of the deceased via online methods is very complex for several reasons:
Online newspapers or notice services are not likely to be read by all of those that knew the deceased, particularly when these are spread over multiple regions or countries. No one service can claim to reach all possible users. Additionally, mourners often need to pay for an online obituary—and these costs are multiplied when several different services need to be used.
Pushing a notice is difficult as the deceased may have multiple contact lists spread across several different applications or platforms. For example, in addition to the contact list on their phone, they may have Facebook friends, Skype contacts, and email contacts. It thus becomes a major chore to track down the contacts of the deceased, combine these with the contacts of the mourners, and send notices to each app/platform;
Further, the notice should ideally include specific information (such as the address/contacts of the grieving family) and an image of the deceased. Creating multiple notices per platform and ensuring that each of these matches the formatting/capabilities of the app and includes all of the relevant information/images is usually not within the capabilities of the mourners.
Once a notice has been received, the recipient is faced with dilemmas about how best to respond, and whether to send a gift such as flowers, food, or other tokens of condolence.
“Walls of remembrance” are available online but these are stand-alone services that do not resolve the issue of reaching out to connections of the deceased and informing them about such a wall.

Attempts have been made in the past to resolve some of these issues. US20140136996 to Salamat requires preconfigured connections between the deceased and trusted contacts for confirming authenticity of an announcement and does not suggest what is to be done if these connections are not set up before the passing. U.S. Pat. No. 5,651,117 to Arbuckle requires manual entry of each contact in order to send out notices and/or requires that parties enter their contact details before the passing and does not suggest what is to be done if sign-up is not made before the passing or if there are a large number of contacts to enter manually. US20140136996 to Boozer et al proposes a virtual remembrance system but does not suggest how contacts of the deceased are to be found or made aware of such a system.

There is therefore a need for a system and method for simple creation of an obituary/notice that can be easily sent to multiple retrieved contacts across multiple platforms. Further, recipients should be presented with simple reply and gift-giving alternatives. Finally, it would be most useful if the mourners could be provided with access to relevant service providers.

### SUMMARY OF THE INVENTION

The present invention overcomes the drawbacks of the prior art by providing a system and method for sending obituaries/notices of death easily to multiple contacts of the deceased that are retrieved from multiple platforms and sent across multiple platforms. Further, recipients are presented with simple reply and gift-giving alternatives. Further, users of the system are provided with access to relevant service providers and these providers enjoy exposure of their services to a relevant audience.

The system enables creation and sending of notices to contact lists. The system comprises a app used by mourners to create and send the notices. The app preferably provides templates and sentences to help make it easier for the user to create the notice. Likewise recipients of a notice are provided with templates and suggestions for responding via a posting on a remembrance wall as well being presented with a simple interface for buying and sending suitable gifts to the grieving family.

The system comprises an advanced vendor interface to enable users to find and select all the necessary services for the funeral and related services or functions. A system administrator can preferably prioritize vendors using a web-based management system that is part of the system. The management system preferably enables tracking of data related to use of the system, managing vendors and gifts for sale and other related functions as described further below.

According to some embodiments of the present invention a method for sending a death notice comprises: creating the notice on a mourner app running on a computing device; retrieving, by a retrieval app running on deceased contact storage, contacts stored in the deceased contact storage and transferring retrieved contacts to the mourner app; sending by the mourner app of the notice to at least one of the retrieved contacts. Preferably the mourner app guides a sender in the creating of the notice.

Preferably the notice comprises information selected from the group consisting of: opening remarks; details about the deceased; date of the funeral; funeral time; cemetery; list of mourners and relation to the deceased; information about mourner visitation; information about other remembrance services; and a combination of the above. Preferably the opening remarks are chosen from templates or from free text entry.

Preferably the notice is viewed by a recipient app running on a computing device. Preferably the recipient app provides for sending a response to the notice and preferably the response comprises at least one of a posting or a gift and wherein the gift is chosen from an online store using the recipient app. Preferably the recipient app guides a recipient to create the posting. Preferably the posting comprises information selected from the group consisting of: Name of mourner; Condolence statement; Name of deceased; name of poster; signature; uploaded image; and a combination of the above.

Preferably the notice is presented on a virtual wall of condolence and preferably the posting is presented on the wall. Optionally the mourner app provides an index of mourning and funeral related services. Preferably the mourner app sends the notice to contacts using different destination platforms. Preferably the notice is formatted according to each of the different destination platforms.

According to further embodiments of the present invention a system for sending a death notice comprises: a mourner app running on a computing device; a retrieval app running on deceased contact storage device; wherein the notice is created using the mourner app and sent by the mourner app to contacts retrieved from the contact storage device by the retrieval app. Preferably the system further comprises a mourning management system running on a computing device and wherein the retrieved contacts are stored on the system and forwarded to the mourner app. Preferably the mourner app guides a sender in the creating of the notice.

Preferably the notice comprises information selected from the group consisting of: opening remarks; details about the deceased; date of the funeral; funeral time; cemetery; list of mourners and relation to the deceased; information about mourner visitation; information about other remembrance services; and a combination of the above. Preferably the opening remarks are chosen from templates or from free text entry.

Preferably the system further comprises a recipient app running on a computing device and wherein the notice is viewed by the recipient app. Preferably the recipient app provides for sending a response to the notice and preferably the response comprises at least one of a posting or a gift and wherein the gift is chosen from an online store using the recipient app. Preferably the recipient app guides a recipient to create the posting and preferably the posting comprises information selected from the group consisting of: Name of mourner; Condolence statement; Name of deceased; name of poster; signature; uploaded image; and a combination of the above.

Preferably the notice is presented on a virtual wall of condolence hosted on the management system. Preferably the posting is presented on the wall. Preferably the mourner app provides an index of mourning and funeral related services. Preferably the mourner app sends the notice to contacts using different destination platforms. Preferably the notice is formatted according to each of the different destination platforms.

According to other embodiments of the present invention a method for sending a death notice comprises: creating the notice on a mourner app running on a computing device; formatting the notice for receiving by a contact on at least one destination platform; sending by the mourner app of the notice to the contact on at least one destination platform. Preferably the mourner app guides a sender in the creating of the notice. Preferably the notice comprises information selected from the group consisting of: opening remarks; details about the deceased; date of the funeral; funeral time; cemetery; list of mourners and relation to the deceased; information about mourner visitation; information about other remembrance services; and a combination of the above. Preferably the opening remarks are chosen from templates or from free text entry.

The terms obituary and notice or death notice are used interchangeably herein and refer to transmittable information relating to a death including but not limited to details opening remarks; details about the deceased; date of the funeral; funeral time; cemetery; list of mourners and relation to the deceased; information about mourner visitation; information about other remembrance services; and a combination of the above. As used herein contacts comprise any data required for establishing communication with the contact including but not limited to: name of the contact, phone number/s, email address/es, social media username/s and so forth.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computing device”, a “computer”, or “mobile device”, it should be noted that optionally any device featuring a data processor and the ability to execute one or more instructions may be described as a computer, including but not limited to any type of personal computer (PC), a server, a distributed server, a virtual server, a cloud computing platform, a cellular telephone, an IP telephone, a smartphone, or a PDA (personal digital assistant). Any two or more of such devices in communication with each other may optionally comprise a “network” or a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

FIG. 1 is an exemplary diagram of a system for mourning management according to at least some embodiments of the present invention;

FIGS. 2A-2J are respectively a flow diagram and exemplary screenshots for sending a notice according to at least some embodiments of the present invention;

FIGS. 3A-3H are respectively a flow diagram and exemplary screenshots for receiving and responding to a notice according to at least some embodiments of the present invention;

FIGS. 4A-4B are exemplary screenshots showing vendor services linked to a mourning management system according to at least some embodiments of the present invention; and

FIGS. 5A-5E are exemplary screenshots showing the management interface of a mourning management system according to at least some embodiments of the present invention.

### DESCRIPTION OF SOME EMBODIMENTS OF THE INVENTION

The present invention in at least some embodiments is a system and method for sending obituaries/notices of death easily to multiple contacts of the deceased that are retrieved from multiple platforms and sent across multiple platforms. Further, recipients are presented with simple reply and gift-giving alternatives. Further, users of the system are provided with access to relevant service providers/vendors and these providers enjoy exposure of their services to a relevant audience.

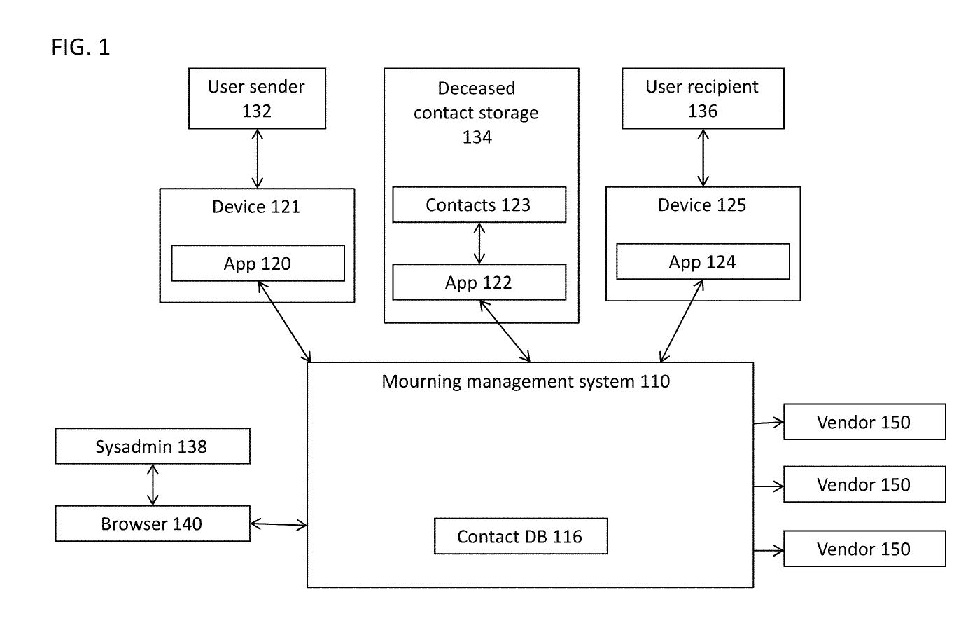

Reference is now made to FIG. 1 which is an exemplary diagram of a system for mourning management according to at least some embodiments of the present invention. As shown in FIG. 1, mourning management system 110 comprises software modules. Management system 110 runs on a computing device which may be a server or multiple servers or distributed servers or any other type of computing device. Notices and postings as described further below are stored on system 110 and gift purchases are managed by system 110 including interaction with vendors 150.

A sending user 132 initiates the sending of a notice and is typically a mourner who is a family member or friend or acquaintance of the deceased. Sending user 132 interacts with management system 110 via mourner app 120. App 120 is a software application that runs on a computing device 121 such as a smartphone.

Deceased contact storage device 134 comprises a store of contacts 123 that the deceased had registered/created on storage device 134. Non-limiting examples of contact storage include computing devices and applications storing any type of contact including but not limited to phone contacts, Facebook friends, and/or Skype contacts, WhatsApp contacts, email contacts and so forth. Retrieval app 122 runs on contact storage 134 to retrieve the contacts of the deceased and is in communication with system 110. App 122 is preferably the same as app 120 but may alternatively be a specialized app 122 for retrieving contacts only.

User recipient 136 responds to a received notice including optionally purchasing a gift for the mourners or posting a condolence posting. Optionally recipient 136 can forward the notice to other recipients. User recipient 136 interacts with system 110 via recipient app 124. App 124 runs on a computing device 125 such as a smartphone and is preferably the same as app 120.

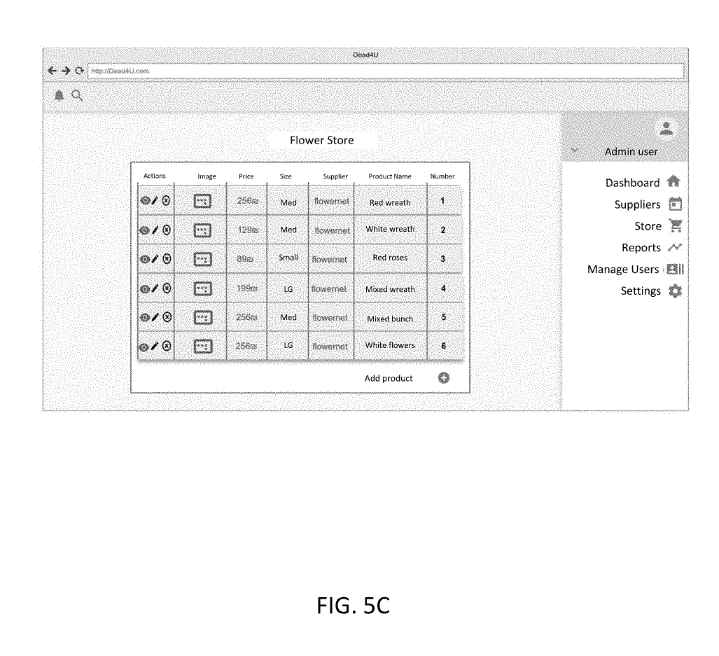

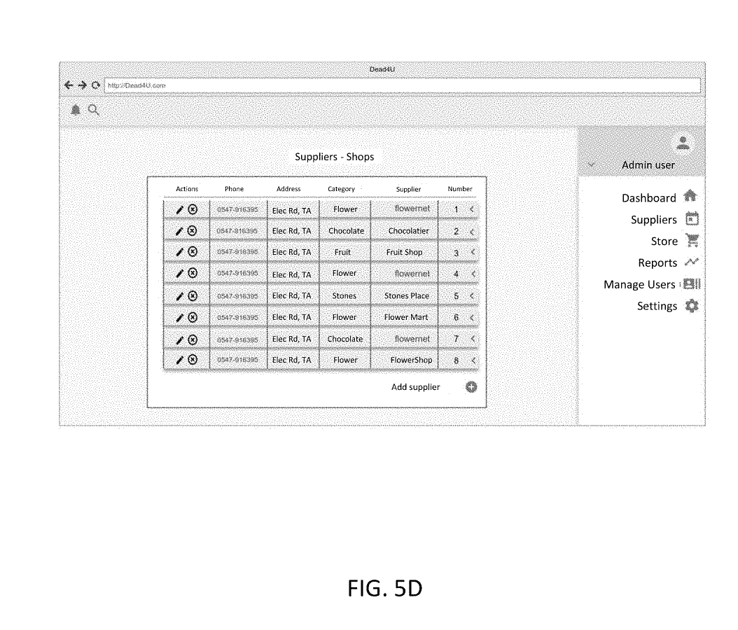

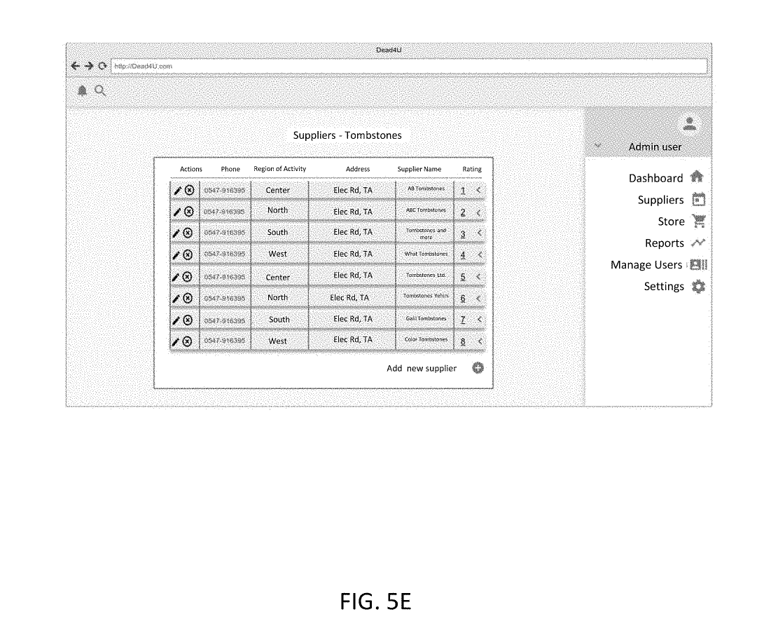

System administrator (sysadmin) 138 manages the operation of system 110 via a Web browser 140 running on a computing device. The functions that sysadmin 138 can control within system 110 are further described below with reference to FIGS. 5A-5E.

Vendors 150 provide gifts for purchase by recipients 136 and also offer services to users 132 and 136.

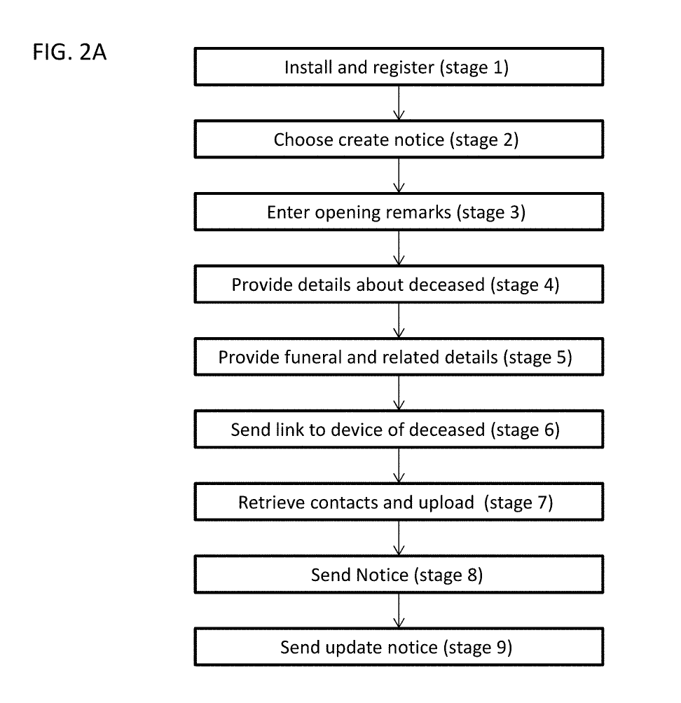

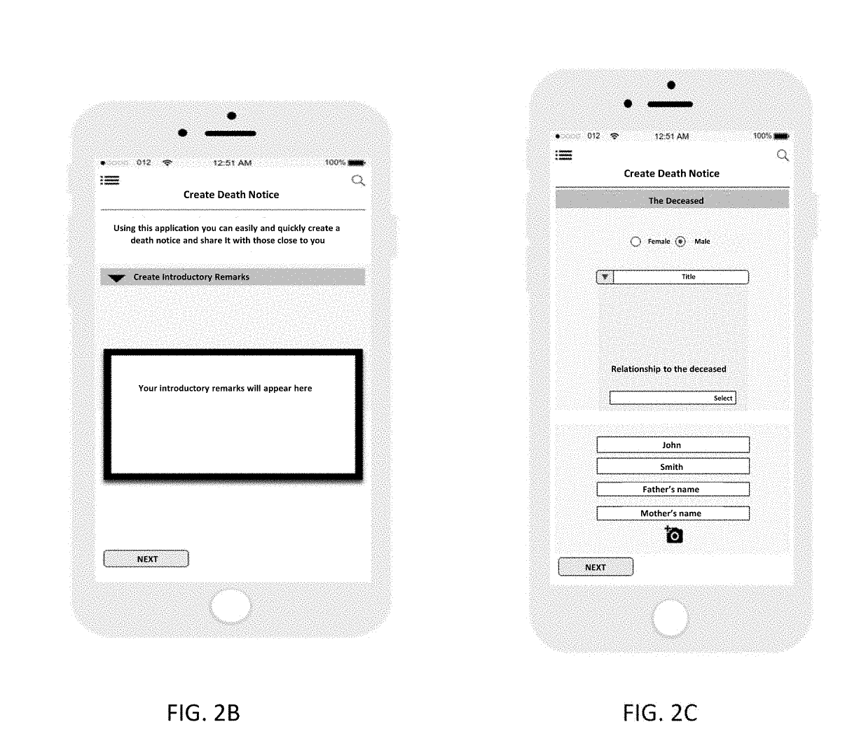

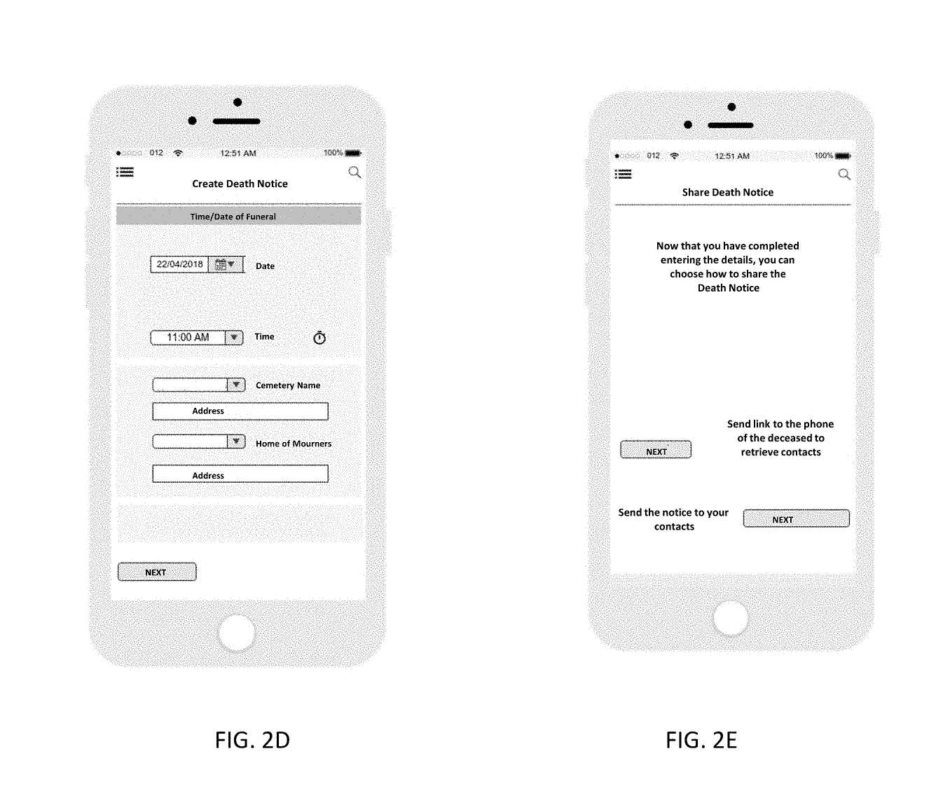

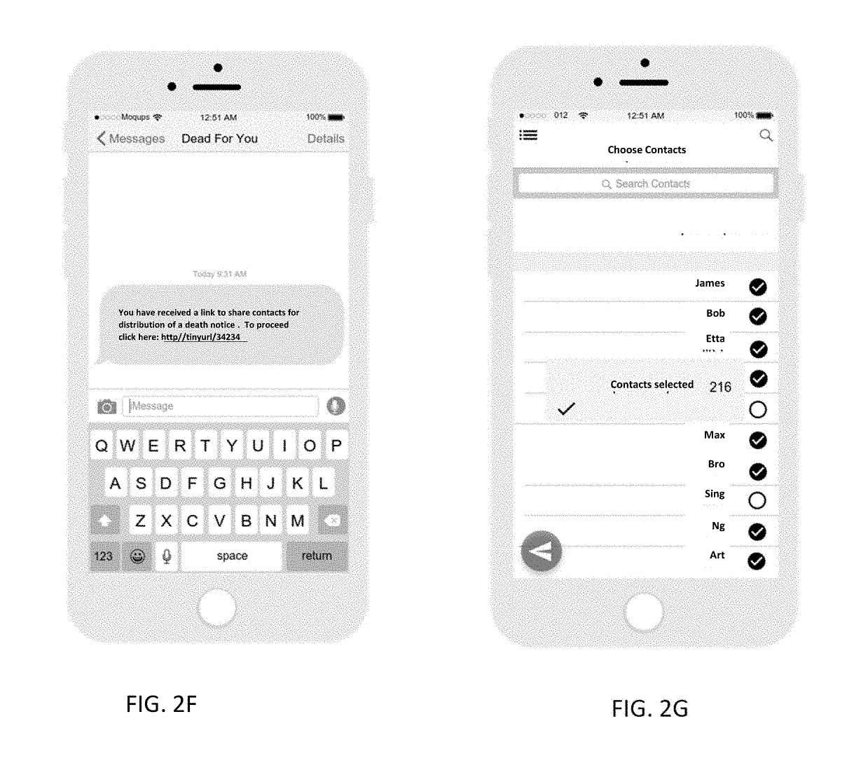

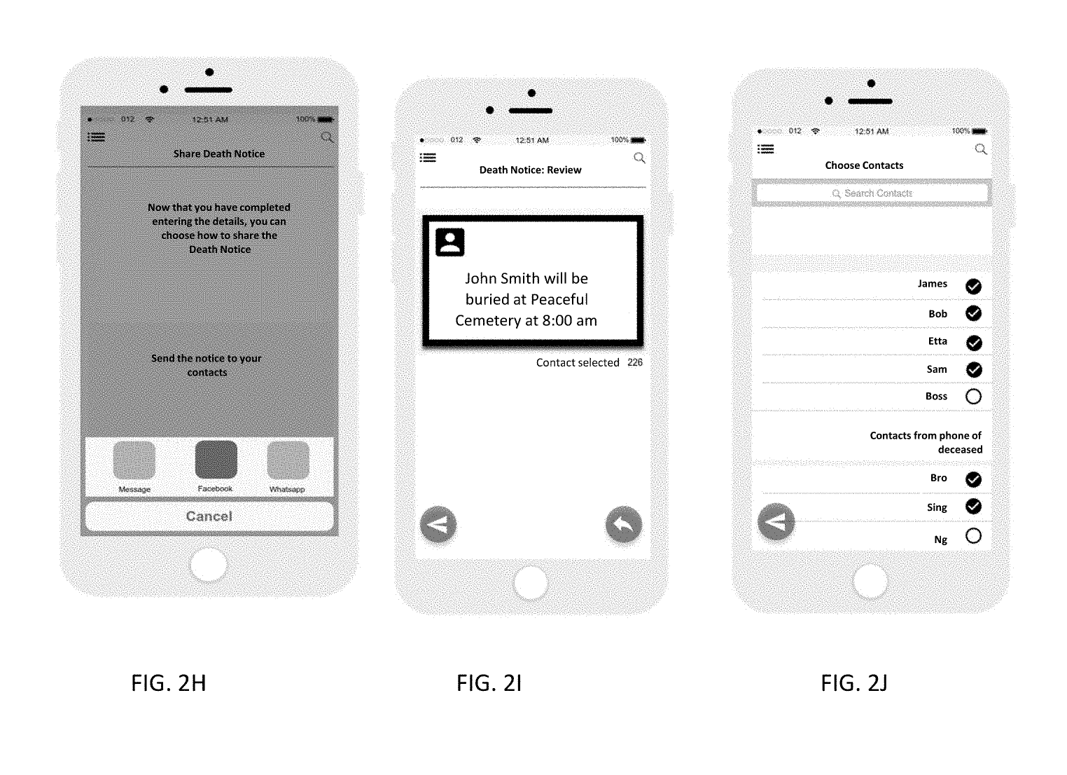

Reference is now made to FIGS. 2A-2J which are respectively a flow diagram and exemplary screenshots for sending a notice according to at least some embodiments of the present invention. As shown in FIG. 2A, in stage 1 sender 132 installs app 120 on a computing device 121. User 132 then registers on system 110 as known in the art. Stage 1 is preferably performed only once per user/device. In stage 2 user 132 opens app 120 and chooses to create a notice from the app menu. In stage 3 sender 132 chooses the opening remarks for the notice such as in the exemplary screenshot of app 120 in FIG. 2B. These remarks may be from a list of suggested sentences so that user 132 does not need to create or word the sentences. Alternatively or additionally sender 132 is provided with free text entry which is preferably limited to less than 200 characters.

In stage 4 sender 132 provides details about the deceased such as in the exemplary screenshot of app 120 in FIG. 2C. Optional information that sender 132 is guided to provide by app 120 includes but is not limited to: Name, Gender, Title of the deceased, relation to sender, names of parents, images of the deceased and so forth to ensure that as much relevant information is collected and not forgotten by user 132.

In stage 5 sender 132 is guided by app 120 to provide funeral and related details such as in the exemplary screenshot of FIG. 2D. These include but are not limited to: date of the funeral (with choices for Gregorian and/or Hebrew date entry), funeral time, cemetery (optionally selected from a database of cemeteries), list of mourners and relation to the deceased, information about mourner visitation, information about other remembrance services, and so forth. Optionally the notice may be previewed at any part of stages 4 and 5 to see how it will look to a recipient 136.

In stages 6-8 sender 132 shares the notice. The sending process comprises several stages. In the exemplary screenshot of FIG. 2E the sending process is explained and the sender is provided with various options as described further below. In stage 6 sender 132 chooses to retrieve the contacts from the contact storage 134 of the deceased. In stage 7 a message is sent to the device 134 of the deceased from system 110 with a link to install app 122 such as shown in the exemplary screenshot of device 134 in FIG. 2F. Optionally, the link is sent directly from app 120 by sender 132. After the app is installed, it scans the device 134 for contacts 123 which can then be reviewed and uploaded to contact DB 116 as shown in exemplary screenshot of app 122 in FIG. 2G. Once uploaded, contacts are preferably de-duplicated. Optionally, retrieved contacts are sent directly to app 120 on the device of sender 132. Retrieved contacts are preferably only displayed on app 120 for selecting contacts to receive notice. Retrieved contacts are preferably not added to those of user 132 on device 121.

In stage 8 sender 132 chooses the platforms/apps and recipient contacts for the notice. Contacts are chosen from the retrieved contact list which is downloaded by app 120 from system 110. FIGS. 2H-2J are exemplary screenshots showing respectively: choice of app/platform for sending notice, preview of the notice to be sent, selection of contacts for receiving the notice. The notice is preferably formatted differently depending on the destination platform/app that is chosen. The platforms/apps for sending the notice include but are not limited to: SMS, WhatsApp, Facebook and similar social media services. Facebook and WhatsApp sending (and sending using other similar services) require the use of such applications installed on the device 121 of sender 132.

Recipients preferably receive a link to a webpage displaying the notice. The webpage preferably comprises the notice as created in stages 3-5 as well as but not limited to: a link to download app 124, an explanation as to why app 124 needs to be downloaded, save the date link/button, a navigate button (to the funeral or home of the mourners), and so forth. As non-limiting examples, SMS recipients will receive a link to view the notice online or a link to download app 124, or a summarized version of the notice along with a link to the notice; WhatsApp recipients will receive an image of the notice and a link to download app 124 or a link to the wall of remembrance.

In optional stage 9, sender 132 can send an update notice such as for funeral or visitation time changes. It is preferably not required for sender 132 to re-choose the intended recipients as these are already recorded in system 110 based on the sending of stage 8. Optionally, intended recipients are selected for the update message.

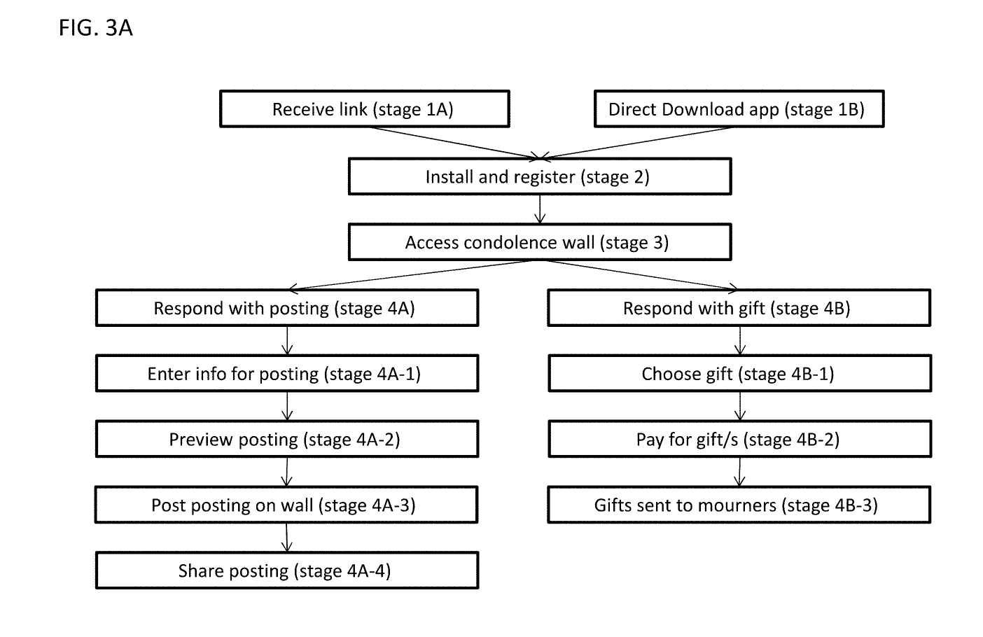

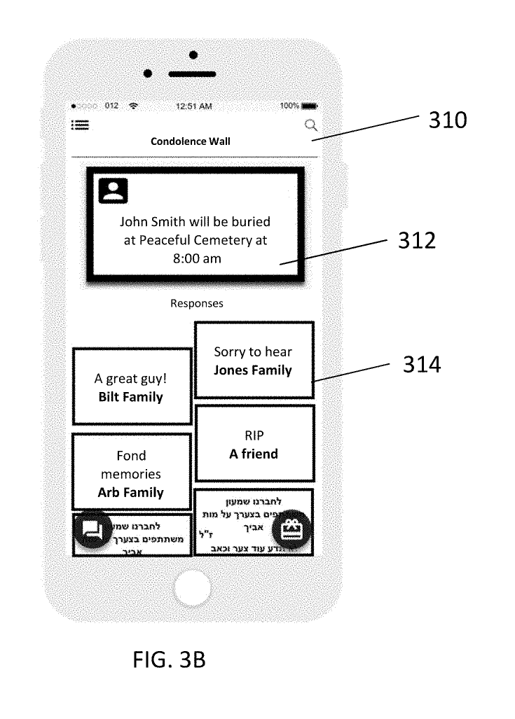

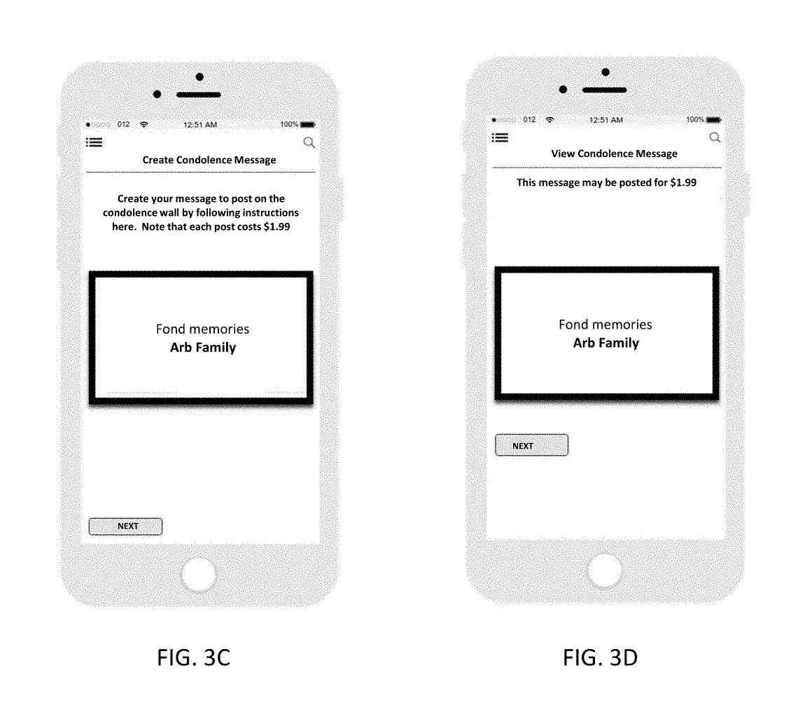

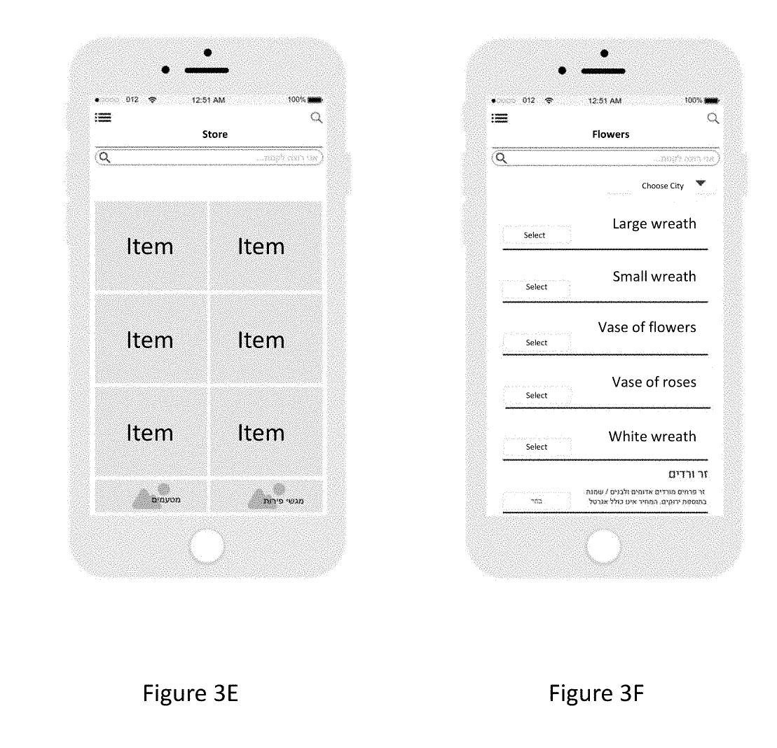

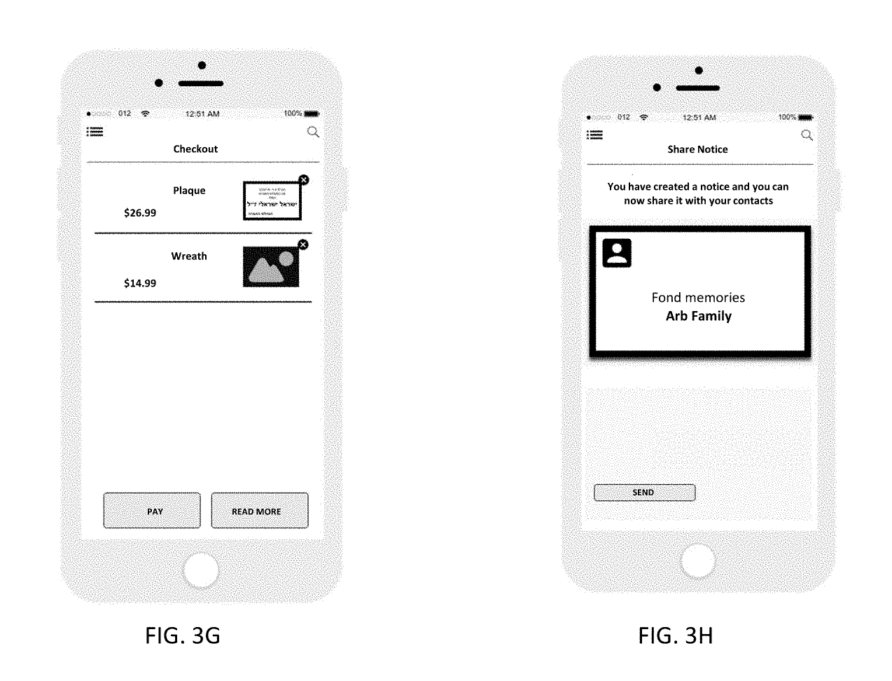

Reference is now made to FIGS. 3A-3H which are respectively a flow diagram and exemplary screenshots for receiving and responding to a notice according to at least some embodiments of the present invention. Preferably recipient 136 receives the notice with the details entered by sender 132 in stages 3-5. Preferably, the notice comprises a link to download app 124 and optionally comprises explanatory text about the use of the app. Optionally recipient receives a link to download app 124 and explanatory text about the use of the app. Most preferably recipient 136 needs to install app 124 to view notice 312 on virtual wall 310 and to post a response 314 or send a gift.

As shown in FIG. 3A, recipient 136 begins interaction with app 124 in one of at least two ways. In stage 1A recipient 136 downloads app 124 in response to a link received from sender 132 as described above (either via a webpage or received directly to device 125). Alternatively as in stage 1B, recipient 136 downloads app 124 directly such as from an online app store.

In both cases, as in stage 2, once the app is downloaded it is installed on device 125 and the recipient 136 runs the app and proceeds with registration as known in the art. In stage 3 recipient 136 uses app 124 to access the virtual wall of condolence 310 as shown in exemplary screenshot of FIG. 3B. The notice 312 created by sender 132 is presented prominently on the wall 310. Optionally notice 312 is gradually displayed in order to encourage recipient 136 to read all parts of notice 312, for example by displaying each sentence or word of notice 312 consecutively, one after another.

Recipients 136 that installed app 124 from a link (stage 1A) are provided with a direct link to wall 310 from within the installed app 124. Recipients 136 that installed app 124 directly (stage 1B) must choose to connect to an existing wall, and then enter details about the deceased in order to access wall 310. Optionally recipient 136 can choose to create a new wall 310 and create a new notice for the deceased.

In stage 4A recipient 136 responds to notice 312 by creating a condolence posting 314. Wall 310 thus comprises notice 312 and postings 314 from recipients 136. In stage 4A-1 recipient 136 provides one or more of the following pieces of information to be added to posting 314: Name of mourner, Condolence statement, Name of deceased, name of poster, signature, uploaded image, and so forth as shown in the exemplary screenshot of FIG. 3C. In stage 4A-2 recipient 136 previews posting 314 as shown in the exemplary screenshot of FIG. 3D and in stage 4A-3 approves the posting 314 which is then posted onto virtual wall 310. Preferably all viewers of the wall can view all postings. Optionally a posting may be private for the sender 132. Preferably sender 132 is notified when a posting 314 is added to wall 310. Recipient 136 is preferably able to modify a posting 314 even after it has been posted.

Additionally or alternatively, in stage 4B, recipient 136 chooses to send a gift to the mourners. In stage 4B-1 recipient 136 chooses from a range of gift categories as shown in the exemplary screenshot of FIG. 3E. Recipient 136 may optionally chooses one or more products as shown in the exemplary screenshot of FIG. 3F. In stage 4B-2 recipient pays and choose delivery options as known in the art and in stage 4B-3 the chosen gifts are sent to the mourners. The exemplary screenshot of FIG. 3G shows a checkout basket of gifts. Preferably the address of the mourners is provided by system 110 and does not need to be provided by recipient 136.

In optional stage 4A-4, recipient 136 can share the created posting 314 as shown in the exemplary screenshot of FIG. 3H. As with the original notice, the posting 314 is shared with a download link to the app 124 over a range of apps/platforms.

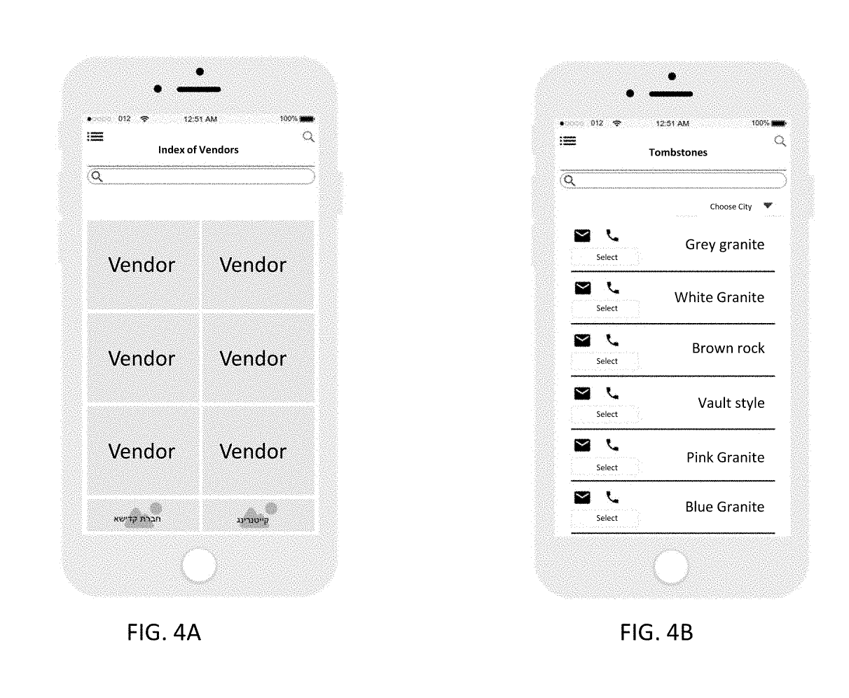

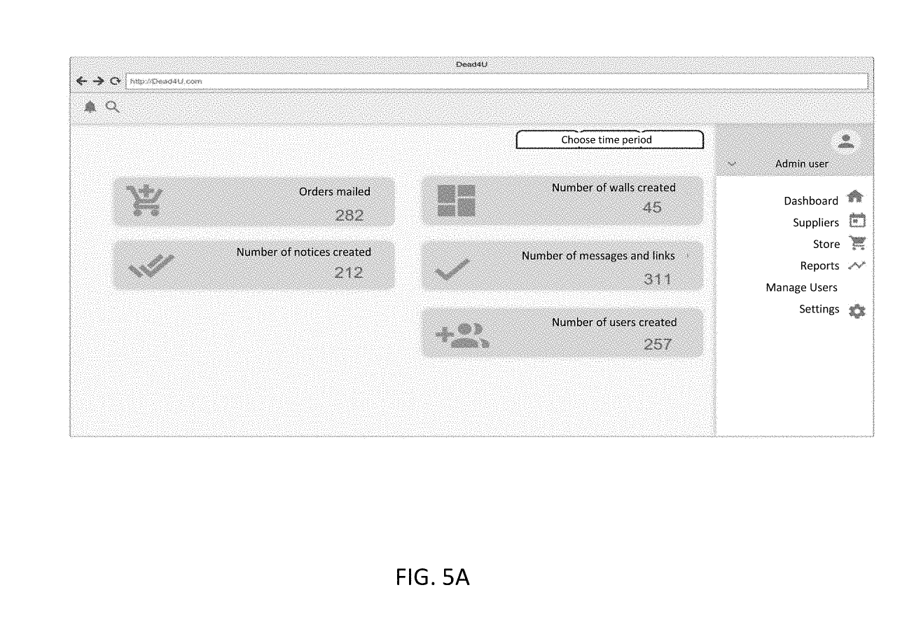

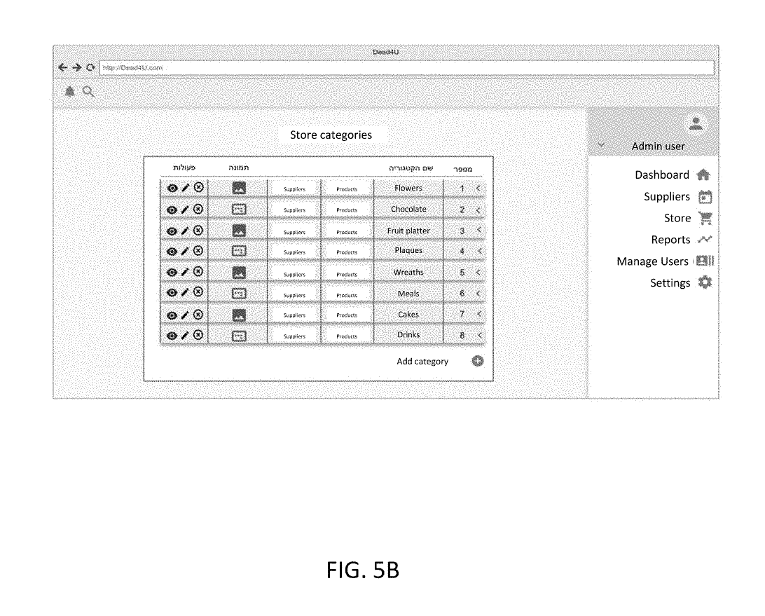

Reference is now made to FIGS. 4A-4B which are exemplary screenshots showing vendor services linked to a mourning management system according to at least some embodiments of the present invention. As shown in FIGS. 4A and 4B, users of apps 120 and 124 (which, as above, may be the same app), can choose from a variety of services provided by vendors 150 who are linked to system 110. FIG. 4A is an exemplary screenshot of vendor categories and FIG. 4B is an exemplary screenshot of vendors in a specific category.

Optionally users 132 and 136 are able to purchase directly from vendors 150 via apps 120, 124. Alternatively only information about vendors 150 is provided such as contact details and service provided and no purchasing is provided via app 120, 124.

Reference is now made to FIGS. 5A-5E which are exemplary screenshots showing the management interface of a mourning management system according to at least some embodiments of the present invention. As above, the management interface is accessed by a Sysadmin 138, preferably via a web browser 150.

As shown in the exemplary screenshot of FIG. 5A, sysadmin 138 can view information about use of system 110. The information that can be viewed includes but is not limited to: Number of walls created, Number of notices and download links sent, Number of users created, Number of gifts shipped, Number of condolence postings created, and so forth. The information can preferably be summarized per time period of interest such as per day month or year.

As shown in the exemplary screenshots of FIGS. 5B-5D, sysadmin 138 can view and manage the gift store of system 110. Non limiting examples of store aspects that can be managed include: Categories (FIG. 5B) including adding, deleting and editing categories or adding images per category or hiding categories; Gifts (FIG. 5C) including adding, deleting and editing gifts per category or adding images per gift or hiding products and entering data about gift providers (FIG. 5D).

As shown in the exemplary screenshot of FIG. 5E, sysadmin 138 can view and manage vendors that are linked to system 110. FIG. 5E illustrates the vendor index. Aspects of vendors that can be managed include: Categories including adding, deleting and editing categories or adding images per category or hiding categories; vendors including adding, deleting and editing vendors and also ranking a vendor to show the vendor higher in the vendor list shown to users.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although a mobile application is shown in the exemplary screenshots above, it should be appreciated that the interface may be on any platform or browser or app and this should not be considered limiting. Although specific wording is shown for the buttons and interface it should be appreciated that the wording, color or style may differ and these should not be considered limiting. The wording, color, layout and information provided in a notice or posting may also differ per territory or culture depending on the mourning/death customs prevalent or local constraints and the screenshots as presented should therefore not be considered limiting. As a non-limiting example some cultures may have several mourning services spread over several days and these would need to be reflected in the notice templates that app 120 provides.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for sending a death notice comprising:
a. creating said notice on a mourner app running on a computing device;
b. retrieving, by a retrieval app running on deceased contact storage, contacts stored in said deceased contact storage and transferring retrieved contacts to said mourner app;
c. sending by said mourner app of said notice to at least one of said retrieved contacts.

2. The method of claim 1 wherein said mourner app guides a sender in said creating of said notice.

3. The method of claim 2 wherein said notice comprises information selected from the group consisting of:
a. opening remarks, wherein said opening remarks are chosen from templates;
b. details about the deceased;
c. date of the funeral;
d. funeral time;
e. cemetery;
f. list of mourners and relation to the deceased;
g. information about mourner visitation;
h. information about other remembrance services; and
i. a combination of the above.

4. (canceled)

5. The method of claim 3 wherein said notice is viewed using a recipient app running on a computing device.

6. The method of claim 5 wherein said recipient app provides for sending a response to said notice, wherein said response comprises at least one of a posting or a gift and wherein said gift is chosen from an online store using said recipient app and wherein said recipient app guides a recipient to create said posting.

7. (canceled)

8. (canceled)

9. The method of claim 6 wherein said posting comprises information selected from the group consisting of:
a. Name of mourner;
b. Condolence statement;
c. Name of deceased;
d. name of poster;
e. signature;
f. uploaded image; and
g. a combination of the above.

10. The method of claim 9 wherein said notice and said posting are presented on a virtual wall of condolence.

11. (canceled)

12. (canceled)

13. The method of claim 1 wherein said mourner app sends said notice to contacts using different destination platforms and wherein said notice is formatted according to each of said different destination platforms.

14. (canceled)

15. A system for sending a death notice comprising:
a. a mourner app running on a computing device;
b. a retrieval app running on deceased contact storage device;
wherein said notice is created using said mourner app and sent by said mourner app to contacts retrieved from said contact storage device by said retrieval app.

16. The system of claim 15 further comprising a mourning management system running on a computing device and wherein said retrieved contacts are stored on said system and forwarded to said mourner app.

17. The system of claim 15 wherein said mourner app guides a sender in said creating of said notice.

18. The system of claim 15 wherein said notice comprises information selected from the group consisting of:
a. opening remarks, wherein said opening remarks are chosen from templates;
b. details about the deceased;
c. date of the funeral;
d. funeral time;
e. cemetery;
f. list of mourners and relation to the deceased;
g. information about mourner visitation;
h. information about other remembrance services; and
i. a combination of the above.

19. (canceled)

20. The system of claim 18 further comprising a recipient app running on a computing device and wherein said notice is viewed using said recipient app.

21. The system of claim 20 wherein said recipient app provides for sending a response to said notice: wherein said response comprises at least one of a posting or a gift and wherein said gift is chosen from an online store using said recipient app and wherein said recipient app guides a recipient to create said posting.

22. (canceled)

23. (canceled)

24. The system of claim 21 wherein said posting comprises information selected from the group consisting of:
a. Name of mourner;
b. Condolence statement;
c. Name of deceased;
d. name of poster;
e. signature;
f. uploaded image; and
g. a combination of the above.

25. The system of claim 24 wherein said notice and said posting are presented on a virtual wall of condolence hosted on said management system.

26. (canceled)

27. (canceled)

28. The system of claim 15 wherein said mourner app sends said notice to contacts using different destination platforms and wherein said notice is formatted according to each of said different destination platforms.

29. (canceled)

30. A method for sending a death notice comprising:
a. creating said notice on a mourner app running on a computing device;
b. formatting said notice for receiving by a contact on at least one destination platform;
c. sending by said mourner app of said notice to said contact on at least one destination platform.

31. The method of claim 30 wherein said mourner app guides a sender in said creating of said notice.

32. The method of claim 31 wherein said notice comprises information selected from the group consisting of:
a. opening remarks wherein said opening remarks are chosen from templates;
b. details about the deceased;
c. date of the funeral;
d. funeral time;
e. cemetery;
f. list of mourners and relation to the deceased;
g. information about mourner visitation;
h. information about other remembrance services; and
i. a combination of the above.

33. (canceled)
